(19) United States
(12) Patent Application Publication
(10) Pub. No.: US 2026/0266700 A1
(43) Pub. Date: Sep. 10, 2026

(54) PARTICLE MONITORING SYSTEM, PORTABLE MICROBIAL AIR SAMPLER, METHOD FOR MONITORING PARTICLES IN A SAMPLE FLUID AND METHOD FOR CALIBRATING/ADJUSTING A PARTCLE MONITORING SYSTEM

(71) Applicants: MERCK PATENT GMBH, DARMSTADT (DE); MBV AG, STAEFA (CH)

(72) Inventors: Luc FELDEN, MOLSHEIM (FR); Beat GLAUSER, STAEFA (CH); Marco HABEGGER, STAEFA (CH)

(73) Assignees: MERCK PATENT GMBH, DARMSTADT (DE); MBV AG, STAEFA (CH)

(21) Appl. No.: 18/847,098

(22) PCT Filed: Mar. 13, 2023
(86) PCT No.: PCT/EP2023/056274

§ 371 Date: Sep. 13, 2024

(30) Foreign Application Priority Data
Mar. 16, 2022 (EP) 22305309.1

(51) Int. Cl. G01N 1/22; G01N 15/06

(52) U.S. Cl. CPC G01N 1/2205; G01N 15/0618

(57) ABSTRACT

The present application relates to a particle monitoring system, to a portable microbial air sampler, to a method for monitoring particles in a sample fluid, such as gases and particularly compressed gases, and to a method for calibrating/adjusting a particle monitoring system.

### TECHNICAL FIELD

The present application relates to a particle monitoring system, to a portable microbial air sampler, to a method for monitoring particles in a sample fluid, such as gases and particularly compressed gases, and to a method for calibrating/adjusting a particle monitoring system.

### BACKGROUND

The monitoring of sample fluids, either of liquids or more commonly of gases like air including compressed gases/air (as used herein the term “compressed” is used to denote a pressure of at least 1.1 bar, preferably at least 1.2 bar), is frequently performed for the purpose of evaluating contaminants, for classification and monitoring purposes, in a range of cleanroom and manufacturing environments requiring low levels of particles, such as cleanroom environments for electronics manufacturing and aseptic environments for manufacturing pharmaceutical and biological products, such as sterile medicinal products.

For the purpose of monitoring air in such a context, particle monitoring systems are known and comprise microbial or active air samplers and particle counters. Microbial or active air samplers and airborne particle counters are beneficial because they allow a user to sample a quantitative amount of air and to determine the risk for contamination (microbial flora) to sterile products in a surrounding environment.

An example of a microbial air sampler and method for sampling, detecting and/or characterizing particles, for example, via collection, growth and analysis of viable biological particles such as microorganisms is disclosed in EP 0 964 240 A1. This device includes an integrated sampler and impact surface, such as the receiving surface of a growth media, for collecting biological particles. The collected particles are then typically incubated to grow living particles and are then analyzed by different techniques including naked eyes inspection, microscopy, fluorescence or auto-fluorescence, ATP detection or others.

A particle counter as the other type of particle monitoring device typically pumps the gas to be monitored through a measuring system. A laser beam is directed into the gas flow and particles crossing the laser beam will create signals that are detected by a photomultiplier. The output of the photomultiplier has several amplifiers with different gain stages that allow discrimination of particle number and particle sizing based on the evaluation of the signals, more specifically of the amplitudes of the signals.

The invention pertains to particle monitoring systems where the sampling section for performing a sampling process on a sample fluid, preferably a gas or compressed gas, such as air or compressed air, which comprises either a particle collector or a particle counter, or one where the sampling section comprises a combination of a particle collector and a particle counter. The monitoring procedure of the particle monitoring systems is as such unaffected by this invention and will not be described in detail.

In a microbial air sampler using the Anderson impaction principle, the air flow is accelerated through a lid with a multitude of tiny nozzles towards a collection plate to allow efficient separation of air-borne microorganisms for downstream analysis. In order to achieve an optimal sampling efficiency without harming the microorganisms, a precisely set flowrate is to be maintained during the sampling process. Similarly, determination of the number of microorganisms per volume of air necessitates highest control of the processed volume. Hence, only microbial air samplers with integrated flow sensors reach optimal capture efficiencies at highest process control.

There are both portable and permanently installed, stationary microbial air samplers available. Portable devices are used for sampling at multiple locations and can be carried around by an operator while stationary devices are often employed together with isolator units in pharmaceutical companies that maintain a sterile environment for example during packaging of drugs. In addition, there exist dedicated devices that enable the sampling of compressed gases as the monitoring of microbial pollution in process gases is critical for many industrial applications, i.e. in pharmaceutical or in food and beverage industries.

Different sensor types have been commercially employed as flow sensors in such devices. Often, these are thermal anemometers that measure the change of a temperature gradient between a heater and a sensor module due to the air flow along these elements. These sensors are very susceptible to the flow conditions of the air and come in bulky housings to control the channel geometries and guide the air flow along the sensor elements. This poses several constraints on the design of the microbial air sampler. In addition, these sensors are relatively costly and measurement uncertainties across the range of different flow rates is typically around ±4% mean variation (m.v.).

Further, many microbial air samplers that employ flow sensing technology are rather bulky and limited in accuracy, especially when a large range of different flow rates is to be correctly qualified. To date, most microbial air samplers therefore have the ability to operate only at one fixed flow rate, typically 100 LPM or 1.0 CFM (28.3 LPM) or 0.1 CFM (2.83 LPM), with “CFM” denoting “cubic feet per minute” and “LPM” denoting “liters per minute”. With ever increasing cleanliness requirements for drug or food production, this leads to the situation that the sampling time often is 10 min or longer for collecting a desired volume of fluid. Portable devices are required to be small and handy. Hence, bulky and heavy flow sensors that additionally require long flow channels for precise measurement are not optimal in such kind of portable devices.

Another problematic field is the calibration/adjustment of such microbial air samplers.

Currently, compressed gas/air samplers are either not calibrated/adjusted at all or need to be sent to a manufacturing or servicing site. In this case, they need to be connected to a big, pressurized tank that can deliver the full pressure range to the instrument thanks to a pressure regulator. Another way is to use pressured bottles, but this will require and consume expensive gas for the only purpose of adjusting/calibrating. The flow rate may, for example, be calibrated/adjusted at 100 LPM and 50 LPM using a reference flow meter.

Further, flow meter designers often need to test new designs of flow meters for accuracy, quality, etc. Most design companies are able to do in-house testing of flow meters using liquids, as the test facilities for liquids can be set up without undue expense or time. By contrast, test facilities for gas are not as common in-house. Thus, anyone wanting to use such a facility usually needs to travel there and pay for its use. This can be costly and time consuming, and for designers has the additional drawback that they cannot benefit from immediate feedback on design changes. As it is frequently, a designer may have to wait weeks or months before being able to test new designs and get test results on the new designs. Thus, the designers and users in general might benefit from a test facility for gas that is small enough and cost effective enough to set up in-house.

There are two main types of test facilities for gas. One type is a blow-down system. In a blow-down system, a compressor takes in air from the atmosphere and compresses the air into a tank. When the pressure in the tank is at the desired pressure for testing, the air is released from the tank and passes through a reference meter and a unit under test (UUT). The air is then vented back to the atmosphere. The reference meter and the UUT measure the flow rate of the gas as it travels from the tank back to the atmosphere. The measurements from the reference meter are used to calibrate/adjust the UUT. Unfortunately, blow-down systems have short runtimes, are costly and inefficient, and are extremely noisy.

Another type of test facility is a re-circulating gas loop. An example of such a test facility is the Metering Research Facility operated by Southwest Research Institute, San Antonio, Texas, USA. It uses a re-circulating gas loop and includes a compressor, a chiller, sonic nozzles, and stations for units under test (UUT). The compressor circulates the gas around the gas loop at a desired flow rate. The compressor adds heat to the gas in the gas loop when it circulates the gas. The chiller cools the gas in the gas loop to a desired temperature. The UUT and one or more sonic nozzles measure the flow rate of the gas. The sonic nozzles are the reference meters for the UUT. The measurements from the UUT are compared to the measurements from the sonic nozzles to verify the accuracy of the meter under test or calibrate/adjust the UUT. A re-circulating gas loop like the Metering Research Facility is very large in size, is costly, and requires a lot of power to operate and thus cannot be effectively assembled and operated in many companies due to size, cost, and power requirements.

An example of a prior art gas test system is disclosed in US 2007/0043976 A1. This gas test system is comprised of a flow loop, a blower system, a temperature control system, a reference meter system, and a unit under test (UUT) system. The UUT system is configured to connect a unit under test (UUT) to the flow loop. With the flow loop pressurized with a gas, the blower system receives the gas under pressure at an inlet. From the pressurized gas at the inlet, the blower system generates a high flow rate of the gas out of an outlet to circulate the gas through the flow loop. The blower system generates a low pressure rise from the inlet to the outlet in generating the high flow rate. The temperature control system receives the flow of gas from the blower system and controls the temperature of the gas. The reference meter system measures a property of the gas circulating through the flow loop. If the UUT in the UUT system also measures a property of the gas circulating through the flow loop, then the measurements of the reference meter system can be compared to the measurements of the UUT to calibrate/adjust the UUT.

The invention aims at providing a particle monitoring system and a method of monitoring particles in a sample fluid, preferably a gas, most preferably a compressed gas, such as air, that can be easily integrated into or realized in a microbial air sampler for compressed gases, preferably air, that employs flow sensing technology, yields lower measurement uncertainties, reduces the device size, in particular to provide a portable device, and has lower costs compared to existing concepts.

The invention also aims at providing a portable microbial air sampler that is small and handy and has lower measurement uncertainties at reduced cost.

The invention finally also aims at providing a method for calibrating/adjusting a portable particle monitoring system, preferably for compressed gas, such as air, that can be relatively simply performed on-site and reduces maintenance calibration/adjustment turnaround time for the users while keeping the highest measurement quality.

### SUMMARY

To solve the problems mentioned above and attain the indicated objectives either singly or in any combination, the present application provides a particle monitoring system as defined by claim 1, a portable microbial air sampler as defined by claim 18, a method for monitoring particles in a sample fluid as defined by claim 12, and a method for calibrating/adjusting a particle monitoring system as defined by claim 16. Preferred embodiments of the systems and of the methods are defined in the respective dependent claims.

The invention in particular provides a particle monitoring system comprising a sampling section for performing a sampling process on a sample fluid flowing through the sampling section, and a sensor arrangement for determining a volume flow rate of the sample fluid flowing through the sampling section, the sensor arrangement associated to a flow path downstream of the sampling section through which the sample fluid flows, in operation, after having passed the sampling section, wherein the sensor arrangement comprises a flow sensor for determining a mass flow rate of the sample fluid flowing through the flow path downstream of the sampling section.

Preferably, the sensor arrangement comprises an absolute pressure sensor for determining an absolute fluid pressure in the flow path, and the flow sensor is arranged in a section of the flow path downstream of the sampling section and downstream of the absolute pressure sensor in the flow direction away from the sampling section.

Preferably, the sensor arrangement comprises a flow rate regulating component that is arranged in the flow path between the absolute pressure sensor and the flow sensor.

Preferably, the particle monitoring system further comprises a control section configured to calculate the volume flow rate of the sample fluid flowing through the sampling section based on the mass flow rate determined by the flow sensor and the absolute fluid pressure determined by the absolute pressure sensor.

Preferably, the sensor arrangement, preferably the flow sensor, comprises a temperature sensor for measuring a temperature of the fluid in the flow sensor.

Preferably, the flow sensor comprises a differential pressure meter for determining a pressure difference of the sample fluid over a given geometrical flow restriction, preferably a nozzle, through which the sample fluid flows, and preferably a temperature sensor for measuring a temperature of the fluid in the differential pressure meter.

Preferably, the control section is configured to calculate the volume flow rate through the sampling section based on the following equation:

$$\dot{{Q}_{H}} = \frac{{T}_{V} \times {k}_{corr} \times {\dot{m}}_{V} \times {p}_{N}}{{p}_{H} \times {T}_{N}}$$

where
\dot{Q}_{H}=volume flow rate through the sampling section (2) [unit: LPM];
T_{V}=fluid temperature in the differential pressure meter [unit: K];
k_{corr}=fluid correction factor characteristic for the type of fluid/gas to be sampled (for air the factor is 1) [unit: none];
\dot{m}_{V}=mass flow rate detected by the differential pressure meter [unit: SLPM];
p_{N}=standard pressure (1013.25 mbar) [unit: mbar];
p_{H}=absolute fluid pressure determined by the absolute pressure sensor (5) [unit: mbar]; and
T_{N}=standard temperature (293.15 K) [unit: K].

Preferably, the control section is configured to allow switching between types of fluid/gas to be sampled by selecting the fluid correction factor characteristic for the respective type of fluid/gas.

Preferably, the control section is configured to be calibrated or adjusted with respect to the fluid flow rate determined by the flow sensor and/or the absolute fluid pressure determined by the absolute pressure sensor.

Preferably, the control section is configured to control a restriction degree of the flow rate regulating component based on the calculated volume flow rate to set the flow rate to a predetermined value.

Preferably, the particle monitoring system further comprises a particle filter, preferably a HEPA filter, that is arranged in the flow path between the sampling section and the flow sensor.

The invention in particular also provides a method for monitoring particles of a sample fluid, the method comprising:
sampling particles in a stream of the sample fluid flowing through a sampling section; and
determining a volume flow rate of the stream of sample fluid flowing through the sampling section by:
determining a mass flow rate of the sample fluid flowing through a flow path downstream of the sampling section,
determining an absolute pressure in the flow path upstream of the position where the mass flow rate is determined and downstream of the sampling section, and
calculating the volume flow rate of the sample fluid flowing through the sampling section based on the determined mass flow rate and the determined absolute pressure.

Preferably, the mass flow rate of the sample fluid flowing through the flow path is determined by measuring a pressure difference of the sample fluid upstream and downstream of a restriction, preferably a nozzle, through which the sample fluid flows.

Preferably, the volume flow rate through the sampling section (2) is calculated based on the following equation:

$$\dot{{Q}_{H}} = \frac{{T}_{V} \times {k}_{corr} \times {\dot{m}}_{V} \times {p}_{N}}{{p}_{H} \times {T}_{N}}$$

where
\dot{Q}_{H}=volume flow rate through the sampling section (2) [unit: L/min];
T_{V}=fluid temperature at the position where the mass flow rate is determined [unit: K];
k_{corr}=fluid correction factor characteristic for the type of fluid/gas to be sampled (for air the factor is 1) [unit: none];
\dot{m}_{V}=mass flow rate [unit: SLPM];
p_{N}=standard pressure (1013.25 mbar) [unit: mbar];
p_{H}=absolute fluid pressure in the flow path determined at a position downstream of the sampling section (2) and upstream of the position where the mass flow rate is determined [unit: mbar]; and
T_{N}=standard temperature (293.15 K) [unit: K], and
wherein, optionally, instead of using the fluid temperature at the position where the mass flow rate is determined, the standard temperature T_{N} may be used.

Preferably, the method for monitoring particles of a sample fluid comprises controlling an opening degree of a flow rate regulating component that is arranged in the flow path between the position where the absolute pressure in the flow path is determined and the position where the pressure difference is measured, based on the calculated volume flow rate to set the flow rate to a predetermined value.

The invention also provides a method for calibrating/adjusting a particle monitoring system according to the invention, comprising the steps:
closing the flow rate regulating component to block the flow path between the absolute pressure sensor and the flow sensor;
connecting an external test fluid source to an inlet of the sampling section of the particle monitoring system and to the flow sensor;
applying a test fluid to the sampling section of the particle monitoring system from the external test fluid source at an ascending and/or descending stepwise sequence of pressures or at continuously ascending and/or descending pressure;
applying a test fluid to the flow sensor from the external test fluid source at an ascending and/or descending stepwise sequence of flow rate values or at continuously ascending and/or descending flow rate;
simultaneously determining the pressures and/or volume flow rate values at the external test fluid source and at the particle monitoring system;
selecting correcting values for distinct selected pressures/volume flow rate levels, preferably by interpolating between the distinct levels by a curve fit, preferably a polynomial curve fit, or by an interpolated look-up table; and
inputting the correcting values into the control section of the particle monitoring system.

Preferably, the correcting values for pressure and flow rate are applied independently and one after the other or simultaneously.

The invention in particular also provides a portable microbial air sampler, preferably for compressed gas, comprising a particle monitoring system according to the invention.

### BRIEF DESCRIPTION OF THE DRAWINGS

The invention is now described in detail on the basis of preferred embodiments by reference to the attached exemplary schematic drawings, in which

FIG. 1 is a schematic exemplary concept diagram of a first preferred embodiment of the present particle monitoring system in a microbial air sampler for sampling compressed gases;

FIG. 2 is a schematic exemplary concept diagram of the setup for calibrating/adjusting a microbial air sampler as described herein for sampling compressed gases;

FIG. 3a shows examples of ascending (left) and descending (right) step-by-step sequences of pressure/flow in the present calibration/adjustment method using the setup of FIG. 2; and

FIG. 3b shows examples of ascending (left) and descending (right) continuous sequences of pressure/flow in the present calibration/adjustment method using the setup of FIG. 2.

### DETAILED DESCRIPTION

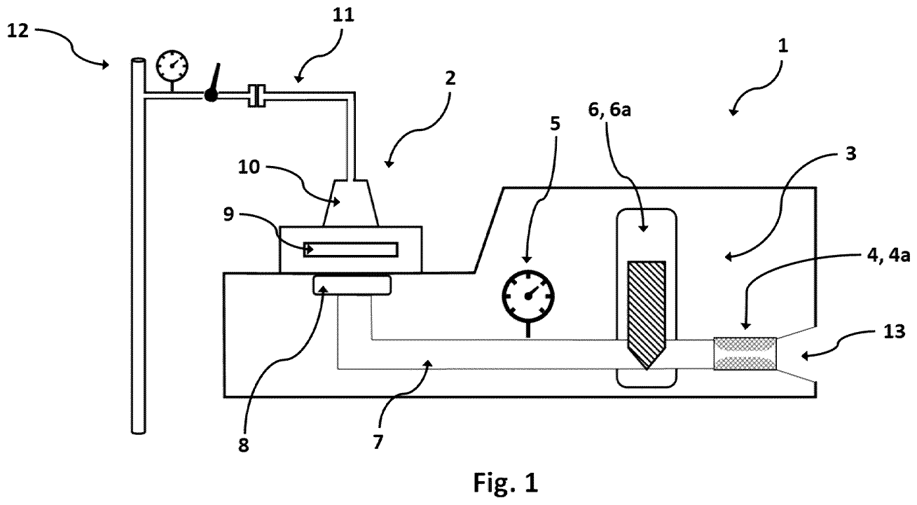

The particle monitoring system of the invention is described using a variant of a microbial air sampler 1 for sampling compressed gases shown in FIG. 1 as an example. Since the monitoring procedure of the particle monitoring system is as such unaffected by this invention, the sampling section 2 of the particle monitoring system for performing a sampling process on a sample fluid, preferably a gas, more preferably a compressed gas is configured as known in the art and the sampling section may comprise one or both of a particle collector and a particle counter as described above (the sampling section 2 in the exemplary embodiment of FIG. 1 is a particle collector).

The particle monitoring system 1 functionally comprises the sampling section 2 for performing a sampling process on a sample fluid flowing through the sampling section 2, and a sensor arrangement 3 for determining a volume flow rate of the sample fluid flowing through the sampling section 2.

In operation the microbial air sampler in which the particle monitoring system is integrated is connected to a gas supply source 12 through a tube or piping 11 such that pressurized gas from the gas supply source 12 passes through the tube 11 to the sampling section 2. The sampling section 2 contains a perforated lid 10 that accelerates the gas and lets particles contained in the gas impinge on a culture medium plate 9 below. Next, the gas passes through a particle filter 8, which is preferably a HEPA filter, that is arranged in a flow path 7 between the sampling section 2 and the sensor arrangement 3, i.e. downstream of the culture medium plate 9, in order to remove any remaining particles or oil residues from the gas.

The sensor arrangement 3 is associated to the flow path 7 through which the sample fluid flows in operation after the sampling operation has been carried out. The sensor arrangement 3 is arranged on the flow path downstream of the sampling section 2 and downstream of the particle filter 8.

The sensor arrangement 3 comprises, in the flow direction from the sampling section 2 to an outlet 13, an absolute pressure sensor 5 for determining an absolute fluid pressure in the flow path 7, and a flow sensor 4 that is arranged in a section of the flow path 7 downstream of the absolute pressure sensor 5 in the flow direction away from the sampling section 2 for determining a mass flow rate of the sample fluid flowing through the flow path 7 downstream of the sampling section 2.

The pressure sensor 5 is configured to determine the absolute gas pressure in the section of the fluid flow path up to a regulating valve 6a. The flow sensor 4 is positioned downstream of the regulating valve 6a and, further downstream, communicates with the outlet 13 that is exposed to ambient pressure conditions. Thus, the flow rate regulating component or valve 6,6a separates the pressurized zone of the present particle monitoring system from the ambient pressure zone, with the flow sensor consequently being in the zone of ambient pressure.

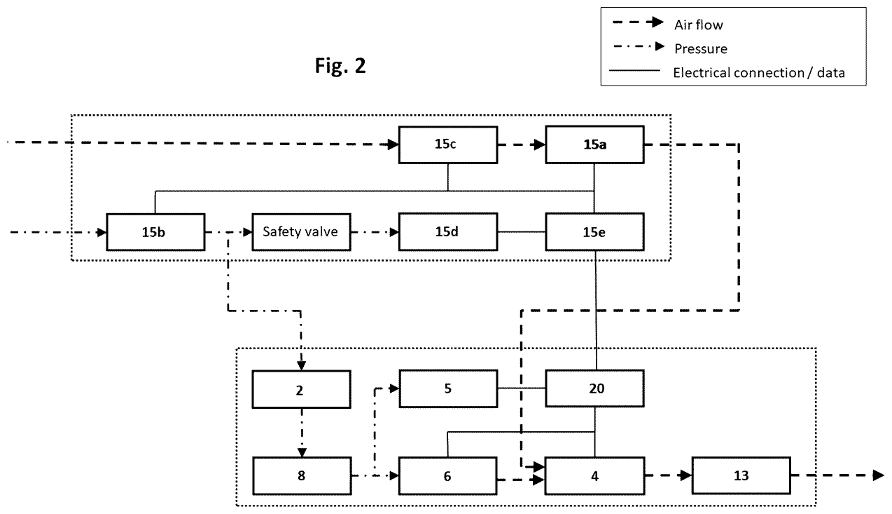

The regulating valve 6a is an example of a flow rate regulating component 6 that is arranged in the flow path 7 between the absolute pressure sensor 5 and the flow sensor 4 for restricting the flow rate through the flow path towards the flow sensor 4. In a preferred embodiment configured for the calibration/adjustment method described later the flow rate regulating component 6 is capable of selectively blocking the flow path 7 between the absolute pressure sensor 5 and the flow sensor 4. In this variant shown in FIG. 2 the particle monitoring system 1 may be provided with a further port or inlet 14 configured to be connected to an external test fluid source 15 for introducing a test fluid into the flow path section downstream of the flow rate regulating component 6 at a defined flow rate and directing it to the flow sensor 4.

The flow sensor 4 in the preferred embodiment comprises a differential pressure meter for determining a pressure difference of the sample fluid over a given geometrical flow restriction 4a (upstream and downstream thereof), preferably a nozzle as schematically indicated in the example, through which the sample fluid flows. Differential pressure meters work, as is known, on the principle of partially obstructing the flow in a pipe. This creates a difference in the static pressure between the upstream and downstream sides of the device. This difference in the static pressure (referred to as the differential pressure or pressure drop) is measured and used to determine the mass flow rate using Bernoulli's equation and conservation of mass, since the differential pressure generated is proportional to the square of the mass flow rate.

While a venturi nozzle type differential pressure meter is preferred in the particular application for a portable or mobile microbial air sampler for the reasons indicated below, other types of differential pressure meters selected from the group consisting of orifice plates, venturi tubes, cone meters (e.g. V-cones or segmental wedge elements), other nozzles, low loss meters (e.g. Dall tubes), variable area meters, inlet flow meters, venturi cones, drag plates, elbow flow elements, Pitot tube, and averaging Pitot tube.

In further alternatives flow sensors working on different physical principles may be employed as well including contact flow sensors like vortex and mechanical or mechatronic flow sensors, or non-contact flow sensors like ultrasonic flow sensors, magnetic-inductive flow sensors, or calorimetric flow sensors, or Coriolis flow sensors.

On the other hand, due to the inherent design configurability of the venturi nozzle type differential pressure meter, i.e. by changing venturi nozzle dimensions and geometry, and the wide range of applicable flow rates, it is possible to separate gas flow rate control (by means of the flow rate regulating component 6) at the point of microbial sampling from gas volume measurement, i.e. the integration of the gas flow to determine the volume of sampled gas. This is beneficial because with the flow sensor 4 being downstream of the sampling section 2 and downstream of the flow regulating component 6, the flow sensor 4 is positioned outside of the pressure path, said pressure path being downstream of the sampling section 2 and upstream of the flow rate regulating component 6, thereby posing lower design requirements on pressure and leak tightness of the flow sensor 4.

The sensor arrangement 3 preferably also comprises a temperature sensor (not shown) for measuring a temperature of the fluid in the flow sensor 4. Alternatively, it is, however, possible to dispense with the temperature sensor and in such case the temperature is assumed to be equal to the standard temperature T_{N}. The sensor may be implemented in the form of a MEMS (micro-electro-mechanical system) differential pressure sensor that measures the differential pressure and temperature and integrates a PCB (printed circuit board) including all electronics needed for temperature corrected flow measurement. Such a sensor configuration yields a high measurement precision over a wide range of applicable flow rates.

One well known disadvantage of differential pressure sensors is the influence that pollution with microparticles can have on the sensor response. This can be a problem and can negatively influence long-term stability. In the invention the particle filter 8 integrated in the particle monitoring system 1 addresses this kind of problem.

The particle monitoring system 1 further comprises a control section 20 configured to calculate the volume flow rate of the sample fluid flowing through the sampling section 2 based on the mass flow rate determined by the flow sensor 4 and the absolute fluid pressure determined by the absolute pressure sensor 5.

The control section 20 is configured to calculate the volume flow rate through the sampling section 2 based on the following equation:

$$\dot{{Q}_{H}} = \frac{{T}_{V} \times {k}_{corr} \times {\dot{m}}_{V} \times {p}_{N}}{{p}_{H} \times {T}_{N}}$$

where
\dot{Q}_{H}=volume flow rate through the sampling section 2 [unit: LPM];
T_{V}=optionally the fluid temperature in the differential pressure meter, or alternatively if sensor arrangement 3 does not comprise a temperature sensor T_{N} [unit: K];
k_{corr}=fluid correction factor characteristic for the type of fluid/gas to be sampled [unit: none];
\dot{m}_{V}=mass flow rate detected by the differential pressure meter [unit: SLPM];
p_{N}=standard pressure (1013.25 mbar) [unit: mbar];
p_{H}=absolute fluid pressure determined by the absolute pressure sensor 5 [unit: mbar]; and
T_{N}=standard temperature (293.15 K) [unit: K].

The control section 20 is configured to allow switching between different types of fluid/gas to be sampled by selecting the fluid correction factor characteristic for the respective type of fluid/gas (for air the factor is 1). Available correction factors for different gas types can be predefined and stored in a software or memory and selected through a switch arrangement or a configuration software.

As described in more detail below the control section 20 is configured to be calibrated/adjusted with respect to the fluid flow rate determined by the flow sensor 4 and/or the absolute fluid pressure determined by the absolute pressure sensor 5.

Further, the control section is configured to control an opening degree of the flow rate regulating component 6, 6a based on the calculated volume flow rate to set the flow rate to a predetermined value.

In the sensor arrangement 3 described above in connection with the exemplary embodiment, the flow sensor has two tasks to fulfil:
i) measuring the mass flow rate of sampled gas; and
ii) providing the measured mass flow rate to the control section 20, thereby allowing the control section 20, together with the measuring results from the pressure sensor 5 and the above equation, to determine the total amount of sampled gas (by integrating over time) and to control the opening degree of the flow rate regulating component 6 (regulating valve 6a). In more detail, based on the measured flow rate through the flow sensor 4 (i.e. in the ambient path communicating with the outlet 13) and the measured absolute pressure (i.e. in the pressure path upstream of the flow sensor and upstream of the flow rate regulating component 6), the flow rate through the sampling section 2 (i.e. in the pressure path) is calculated. This calculated flow rate is then compared to a target flow rate. As a result of this comparison, the restriction degree of the flow rate regulating component 6 is either increased or decreased to adjust the flow rate through the flow path 7 that reaches the flow sensor 4.

The architecture allows sampling of microorganisms under pressure. This means that the gas to be sampled does not undergo rapid pressure or temperature changes before sampling for the purpose of determining the flow rate so that the gas-carried microorganisms are not getting damaged by rapidly changing conditions.

Under consideration of the relatively small dimensions of the components of the particle monitoring system, the invention can realize a portable or mobile microbial air sampler, preferably for compressed gases like air, comprising the particle monitoring system according to invention provided in a housing.

On the basis of the principles described above in connection with the exemplary particle monitoring system, the invention also provides, independent from that particular device structure, a method for monitoring particles of a sample fluid, comprising the following steps:
sampling particles in a stream of the sample fluid flowing through a sampling section 2; and
determining a volume flow rate of the stream of sample fluid flowing through the sampling section 2 by:
determining a mass flow rate of the sample fluid flowing through a flow path downstream of the sampling section 2;
determining an absolute pressure in the flow path upstream of the position where the mass flow rate is determined and downstream of the sampling section 2;
optionally determining the temperature in the flow sensor/differential pressure meter 4; and
calculating the volume flow rate of the sample fluid flowing through the sampling section 2 based on the determined mass flow rate and the determined absolute pressure and the temperature (if the temperature is not specifically determined, the temperature is assumed to be equal to the standard temperature T_{N}).

The mass flow rate of the sample fluid flowing through the flow path is determined by measuring a pressure difference of the sample fluid upstream and downstream of a restriction, preferably a nozzle, through which the sample fluid flows. The volume flow rate through the sampling section 2 can be calculated based on the equation explained above.

The method for monitoring particles of a sample fluid may also comprise controlling an opening degree of a flow rate regulating component 6 that is arranged in the flow path between the position where the absolute pressure in the flow path is determined and the position where the pressure difference is measured, based on the calculated volume flow rate to set the flow rate to a predetermined value.

On the basis of a particle monitoring system that includes the flow rate regulating component 6 in the flow path between the position where the absolute pressure in the flow path is determined and the position where the pressure difference is measured with a configuration that allows substantially complete selective blocking of the flow path closing the flow rate regulating component 6;6a (or by a further valve specifically adapted and dedicated to blocking the flow path) to block the flow path 7 between the absolute pressure sensor 5 and the flow sensor 4, the invention provides a method for calibrating/adjusting a particle monitoring system 1, preferably in a mobile microbial air sampler for sampling compressed gases, that is based on a test setup shown in the schematic concept diagram of FIG. 2 for calibrating/adjusting the air sampler.

The invention thus provides a solution to the initially described problems with existing large-scale gas test systems. It allows to calibrate/adjust the compressed gas air sampler like the one described above in connection with FIG. 1 (unit under testing—UUT) which performs the air sampling under pressure on site using only a portable instrument (external test fluid source 15) that can deliver the right pressure range and flow rate after gas decompression to 1 atm. The calibration/adjustment method separates the pressure from the flow calibration/adjustment and therefore removes the constraints of generating a high flow rate at a high pressure.

The method comprises the following steps:
completely closing the flow rate regulating component 6;6a or the further valve specifically adapted and dedicated to blocking the flow path to block the flow path 7 between the absolute pressure sensor 5 and the flow sensor 4;
connecting an external test fluid source 15 to an inlet of the sampling section 2 of the particle monitoring system 1 and to the flow sensor 4 (for example via the separate port 14);
applying a test fluid to the sampling section 2 of the particle monitoring system 1 from the external test fluid source 15 at an ascending and/or descending stepwise sequence of pressures or at continuously ascending and/or descending pressure;
applying a test fluid to only the flow sensor 4 from the external test fluid source 15 at an ascending and/or descending stepwise sequence of flow rate values or at continuously ascending and/or descending flow rate;
simultaneously determining the pressures and/or volume flow rate values at the external test fluid source and at the particle monitoring system 1;
selecting correcting values for distinct selected pressures/volume flow rate levels, preferably by interpolating between the distinct levels by an appropriate (for example: polynomial) curve fit or by an interpolated look-up table; and
inputting the correcting values into the control section of the particle monitoring system 1.

The correcting values for any one or more of temperature, pressure and flow rate are applied independently and one after the other or simultaneously.

With this test setup, the invention, unlike the prior art techniques, the gas (here it is ambient air) doesn't need to be temperature-controlled as the warming will not affect the pressure sensor calibration/adjustment and the compressed air is not used to calibrate/adjust the flow sensor. Indeed, advantageously, the flow rate calibration/adjustment of the flow sensor 4 bypasses the flow rate regulating component of the UUT and uses the ambient air.

Therefore, both flow sensors (the one from the external test fluid source 15 and the one from the UUT) see the same air flow (as there is no flow restriction between the two) and at the same temperature (as there is no decompression of the gas/air).

As compared to bulky dedicated gas test systems or facilities, the calibration/adjustment method of the invention provides advantages in that it is a portable solution, in that it reduces maintenance turnaround time and cost, it ensures metrology good practices, it provides for the possibility of a fully automated calibration/adjustment that excludes or significantly reduces risk of human error, in that it is applicable to the full pressure range and full flow rate range calibration/adjustment, in that it can be configured as a “Plug and Play” concept with respect to the compressed gas air sampler as the UUT, in that it reduces risk intrinsically linked to the use of high pressure and high volume of gases associated to the use of a pressure tank in certain existing test gas systems, and it avoids the necessity for a user to provide and stock compressed gas containers (bottles) for calibration purposes.

The external test fluid source 15 for performing the calibration/adjustment method of the invention using ambient air includes, as shown in FIG. 2, a flow generator 15a (for example an axial or centrifugal fan or blower) and a flow sensor 15c that are capable of generating and measuring the full flow rate for the respective compressed gas air sampler to be tested (UUT) after gas decompression to 1 atm (for example, 50 SLPM to 700 SLPM, with “SLPM” denoting “standard liters per minute”), a pressure generator 15b and a pressure sensor 15d (for example a mechanical compressor) that is capable of generating and measuring the full pressure range for the respective compressed gas air sampler to be tested (UUT) (for example a range of 1.1, preferably 1.2 to 7 bars absolute), and a controller 15e for receiving the measuring results and communicating with the UUT.

The pressure and flow sensor of the external test fluid source 15 are mirroring the one of the UUT. The external test fluid source 15 itself (and its sensors) is calibrated/adjusted by the provider of the sensors or at manufacturing site in order to have a high-grade calibration/adjustment.

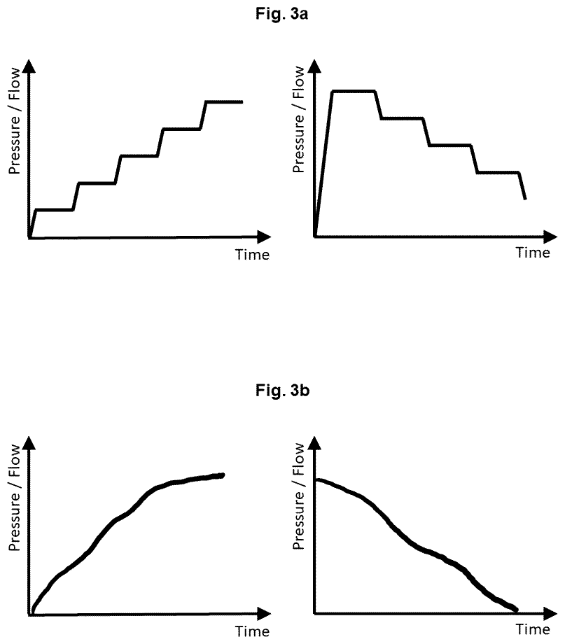

First, the flow rate regulating component 6 (valve) of the UUT or the further valve specifically adapted and dedicated to blocking the flow path is closed such that the pressure generator 15b of the external test fluid source 15 can pressurize the pressure sensors of both the external test fluid source 15 and the UUT (i.e. the pressure sensor 15d and the absolute pressure sensor 5) with the same pressure. The sequence can make steps with switching on/off the pressure generator 15b. The consequence is a sequence with plateau such that the acquisition on both sensors is made under a steady condition. At each step, the pressure is monitored on both sensors 5, 15d. As an option, after having pressurized the pressure path, the flow rate regulating component 6 (valve) of the UUT can repeatedly be opened and closed to proceed a step-by-step descending sequence (see FIG. 3a).

Alternatively, the flow rate regulating component 6 (valve) of the UUT can just be slightly opened such that the air exhaust slowly with the consequence of doing a continuously descending sequence (see FIG. 3b).

A descending sequence can be done after an ascending sequence in order to gather more datasets for the calibration/adjustment but is not mandatory. Such gathering of more datasets may, however, be useful to determine whether any hysteresis effect exists, and, if so, assess its effect. Such gathering of more datasets may also be used for determining a “mean” or “average” dataset, which may subsequently be used in the calibration/adjustment. A step-by-step sequence can follow a continuous sequence and vice versa.

The absolute pressure sensor 5 of the UUT is then re-adjusted based on an appropriate (for example: polynomial) curve fit or an interpolated look-up-table (LUT). Therefore, from a discrete number of datasets acquired during the adjustment sequence, one can obtain the adjusted pressure on the UUT.

When using the curve fit method for the calibration/adjustment of the absolute pressure sensor 5 of the UUT, the UTT values are derived from the inverse function UUT pressure=f⁻¹(X).

When using a LUT, the UUT values are derived by interpolation (if the inputs fail to match index values in the breakpoint datasets).

For the interpolation all common interpolation methods known in the art apply including (but not limited to) flat (which disables interpolation), nearest (which disables interpolation and returns the table value corresponding to the breakpoint closest to the input), linear point-slope (which fits a line between the adjacent breakpoints and returns the point on that line corresponding to the input), cubic spline (which fits a cubic spline to the adjacent breakpoints and returns the point on that spline corresponding to the input), linear Lagrange (which fits a line between the adjacent breakpoints using first order Lagrange interpolation), and Akima spline (which fits an Akima spline to the adjacent breakpoints and returns the point on that spline corresponding to the input).

The same type of methodology as described above for calibrating/adjusting the absolute pressure sensor 5 of the UUT is applied for calibrating/adjusting the flow sensor 4 (for this reason the diagrams in FIG. 3 indicate both pressure and flow as a label of the ordinate).

For calibrating/adjusting the flow sensor 4 the flow generator 15a (blower/fan) is operated to blow air through the mass flow sensor 15d of the external test fluid source 15 and the flow sensor 4 of the UUT. As the flow sensor 4 of the UUT is located downstream of the (closed) flow rate regulating component 6 (valve) and the air is introduced into the flow path 7 between the regulating component 6 and the flow sensor 4, the air flow coming from the external test fluid source 15 can bypass the flow rate regulating component 6 and is subject to a lower or no flow restriction. The flow rate produced by the flow generator 15a is increased (for example by increasing the rotating speed of the blower/fan) step by step or continuously as described above in connection with the calibration/adjustment of the pressure sensor. The mass flow rates are measured simultaneously mass flow sensor 15c of external test fluid source 15 and the flow sensor 4 of the UUT for each step or in a continuous manner.

The flow rate can also be decreased step by step or continuously and the ascending and descending sequence can be combined to add more datasets.

These values are used to re-adjust/calibrate the flow sensor 4 of the UUT based on a polynomial curve fit or an interpolated look-up-table (LUT) just as described above in connection with the pressure calibration/adjustment), for example by inputting the correcting values into the control section of the particle monitoring system 1 of the UUT.

Finally, the flow rate regulating component 6 (valve) or—if provided—the dedicated closing valve (i.e. the further valve specifically adapted and dedicated to blocking the flow path) of the UUT may be re-opened and the external test fluid source 15 is disconnected from the UUT and the port 14 for introducing the air flow between the flow rate regulating component 6 (or the dedicated closing valve, if provided) and the flow sensor 4 is closed.

The calibration/adjustment sequence can use 1) an increasing pressure and flow rate or 2) a decreasing of pressure and flow rate or 3) a combination of both.

Pressure and flow rate adjustment/calibration can be performed one after the other or can be performed simultaneously with the benefit of reducing calibration and adjustment time. In this latter case the flow rate regulating component 6 (or the dedicated closing valve, if provided) needs to be kept closed to avoid that the pressure application influences the flow rate measurement.

The calibration/adjustment method of the invention has been described using the compressed gas air sampler with a particle monitoring system 1 of the invention as an example for the UUT. The calibration/adjustment method of the invention can, however, be applied to other types of air samplers including fixed or stationary air samplers and it can be applied to existing air samplers that are equipped with the flow rate regulating component (valve) between the absolute pressure sensor and the flow sensor.

The present particle monitoring system differs from conventional, known ones particularly in respect to the placement of the flow sensor, which is of interest particularly in the monitoring of compressed gases. The flow sensor of the present system is no longer placed in the pressurized zone but is located in a zone of ambient pressure, with pressurized and ambient pressure zones preferably being separated from each other by a valve (for example, flow rate regulating component or valve 6, 6a). This particular difference offers significant advantages over known designs, for example, by allowing for easier and simplified assembly, increased lifetime of the flow sensor, and/or improved reliability of the flow sensor.

Furthermore, as the flow sensor no longer needs to be designed in such a way as to withstand increased pressures, a wider range of suitable and potentially more accurate and reliable flow sensors becomes available, thereby allowing to improve the overall accuracy of the present particle monitoring system as well as allowing improved adaptation to specific requirements. As a further benefit, the wider range of suitable flow sensors allows for improved supply security, which due to the COVID pandemic and the resulting supply chain disruptions has recently become a cause of concern for manufacturers.

Locating the flow sensor outside the pressurized zone of the particle monitoring system furthermore allows for a separation of flow and pressure, thereby excluding any influences or cross-sensitivity of pressure on the flow sensor and consequently the accuracy of the flow measurement. This improved accuracy of the present particle monitoring system is of particular benefit for, and in fact is responsible for allowing, calibration of flow in the present particle monitoring system at ambient pressure. In addition, this allows for simultaneous (i.e. not sequential, as in conventional particle monitoring systems) pressure and flow calibration.

The specific arrangement of components of the present particle monitoring system as defined herein furthermore allows for a portable calibration system, thereby permitting on-site calibration. This also avoids the need of either maintaining an in-house calibration laboratory or bench-top calibration instrument, the maintenance and running of which is associated with significant efforts and costs, or of shipping the particle monitoring system to a specific calibration service. Not having to ship the particle monitoring system will avoid the risks of the instrument getting damaged during transport and further avoids the inconvenience that the user either has to own or rent a back-up particle monitoring system while the to-be-calibrated instrument is off-site.

1. A particle monitoring system (1) comprising:
a sampling section (2) for performing a sampling process on a sample fluid flowing through the sampling section (2); and
a sensor arrangement (3) for determining a volume flow rate of the sample fluid flowing through the sampling section (2), the sensor arrangement (3) associated to a flow path (7) downstream of the sampling section (2) through which the sample fluid flows, in operation, after having passed the sampling section (2),
wherein the sensor arrangement (3) comprises a flow sensor (4) for determining a mass flow rate of the sample fluid flowing through the flow path (7) downstream of the sampling section (2).

2. The particle monitoring system (1) according to claim 1, wherein the sensor arrangement (3) comprises an absolute pressure sensor (5) for determining an absolute fluid pressure in the flow path (7), and the flow sensor (4) is arranged in a section of the flow path (7) downstream of the sampling section (2) and downstream of the absolute pressure sensor (5) in the flow direction away from the sampling section (2).

3. The particle monitoring system (1) according to claim 2, wherein the sensor arrangement (3) comprises a flow rate regulating component (6;6a) that is arranged in the flow path (7) between the absolute pressure sensor (5) and the flow sensor (4).

4. The particle monitoring system (1) according to claim 3, further comprising a control section (20) configured to calculate the volume flow rate of the sample fluid flowing through the sampling section (2) based on the mass flow rate determined by the flow sensor (4) and the absolute fluid pressure determined by the absolute pressure sensor (5).

5. The particle monitoring system (1) according to claim 1, wherein the sensor arrangement (3) comprises a temperature sensor for measuring a temperature of the fluid in the flow sensor (4).

6. The particle monitoring system (1) according to claim 1, wherein the flow sensor (4) comprises a differential pressure meter for determining a pressure difference of the sample fluid over a given geometrical flow restriction through which the sample fluid flows.

7. The particle monitoring system (1) according to claim 4, wherein the flow sensor (4) comprises a differential pressure meter for determining a pressure difference of the sample fluid over a given geometrical flow restriction through which the sample fluid flows, and wherein the control section (20) is configured to calculate the volume flow rate through the sampling section (2) based on the following equation:
$$\dot{{Q}_{H}} = \frac{{T}_{V} \times {k}_{corr} \times {\dot{m}}_{V} \times {p}_{N}}{{p}_{H} \times {T}_{N}}$$
where
\dot{Q}_{H}=volume flow rate through the sampling section (2) [unit: LPM];
T_{V}=fluid temperature in the differential pressure meter, or alternatively if sensor arrangement 3 does not comprise a temperature sensor T_{N} [unit: K];
k_{corr}=fluid correction factor characteristic for the type of fluid/gas to be sampled (for air the factor is 1) [unit: none];
\dot{m}_{V}=mass flow rate detected by the differential pressure meter [unit: SLPM];
p_{N}=standard pressure (1013.25 mbar) [unit: mbar];
p_{H}=absolute fluid pressure determined by the absolute pressure sensor (5) [unit: mbar]; and
T_{N}=standard temperature (293.15 K) [unit: K].

8. The particle monitoring system (1) according to claim 7, wherein the control section (20) is configured to allow switching between types of fluid/gas to be sampled by selecting the fluid correction factor characteristic for the respective type of fluid/gas.

9. The particle monitoring system (1) according to claim 4, wherein the control section (20) is configured to be calibrated or adjusted with respect to the fluid flow rate determined by the flow sensor (4) and/or the absolute fluid pressure determined by the absolute pressure sensor (5).

10. The particle monitoring system (1) according to claim 4, wherein the control section (20) is configured to control a restriction degree of the flow rate regulating component (6,6a) based on the calculated volume flow rate to set the flow rate to a predetermined value.

11. The particle monitoring system (1) according to claim 1, further comprising a particle filter (8) that is arranged in the flow path (7) between the sampling section (2) and the flow sensor (4).

12. A method for monitoring particles of a sample fluid, the method comprising:
sampling particles in a stream of the sample fluid flowing through a sampling section (2); and
determining a volume flow rate of the stream of sample fluid flowing through the sampling section (2) by:
determining a mass flow rate of the sample fluid flowing through a flow path downstream of the sampling section (2),
determining an absolute pressure in the flow path upstream of the position where the mass flow rate is determined and downstream of the sampling section (2), and
calculating the volume flow rate of the sample fluid flowing through the sampling section (2) based on the determined mass flow rate and the determined absolute pressure.

13. The method for monitoring particles of a sample fluid according to claim 12, wherein the mass flow rate of the sample fluid flowing through the flow path is determined by measuring a pressure difference of the sample fluid upstream and downstream of a restriction, preferably a nozzle, through which the sample fluid flows.

14. The method for monitoring particles of a sample fluid according to claim 13, wherein the volume flow rate through the sampling section (2) is calculated based on the following equation:
$$\dot{{Q}_{H}} = \frac{{T}_{V} \times {k}_{corr} \times {\dot{m}}_{V} \times {p}_{N}}{{p}_{H} \times {T}_{N}}$$
where
\dot{Q}_{H}=volume flow rate through the sampling section (2) [unit: L/min];
T_{V}=fluid temperature at the position where the mass flow rate is determined [unit: K];
k_{corr}=fluid correction factor characteristic for the type of fluid/gas to be sampled (for air the factor is 1) [unit: none];
\dot{m}_{V}=mass flow rate [unit: SLPM];
p_{N}=standard pressure (1013.25 mbar) [unit: mbar];
p_{H}=absolute fluid pressure in the flow path determined at a position downstream of the sampling section (2) and upstream of the position where the mass flow rate is determined [unit: mbar]; and
T_{N}=standard temperature (293.15 K) [unit: K], and
wherein, optionally, instead of using the fluid temperature at the position where the mass flow rate is determined, the standard temperature may be used,
preferably the method comprising controlling an opening degree of a flow rate regulating component (6;6a) that is arranged in the flow path between the position where the absolute pressure in the flow path is determined and the position where the pressure difference is measured, based on the calculated volume flow rate to set the flow rate to a predetermined value.

15. A method for calibrating/adjusting a particle monitoring system (1) according to claim 9, comprising the steps:
closing the flow rate regulating component (6;6a) to block the flow path (7) between the absolute pressure sensor (5) and the flow sensor (4);
connecting an external test fluid source (15) to an inlet of the sampling section (2) of the particle monitoring system (1) and to the flow sensor (4);
applying a test fluid to the sampling section (2) of the particle monitoring system (1) from the external test fluid source (15) at an ascending and/or descending stepwise sequence of pressures or at continuously ascending and/or descending pressure;
applying a test fluid to the flow sensor (4) from the external test fluid source (15) at an ascending and/or descending stepwise sequence of flow rate values or at continuously ascending and/or descending flow rate;
simultaneously determining the pressures and/or volume flow rate values at the external test fluid source and at the particle monitoring system (1);
selecting correcting values for distinct selected pressures/volume flow rate levels, preferably by interpolating between the distinct levels by a curve fit, preferably a polynomial curve fit, or by an interpolated look-up table; and
inputting the correcting values into the control section (20) of the particle monitoring system (1),
preferably wherein the correcting values for pressure and flow rate are applied independently and one after the other or simultaneously.

16. A portable microbial air sampler, preferably for compressed gas, comprising a particle monitoring system according to claim 1.

17. The particle monitoring system (1) according to claim 5, wherein the flow sensor (4) comprises the temperature sensor for measuring a temperature of the fluid in the flow sensor (4).

18. The particle monitoring system (1) according claim 1, wherein the flow sensor (4) comprises a differential pressure meter for determining a pressure difference of the sample fluid over a nozzle through which the sample fluid flows, and a temperature sensor for measuring a temperature of the fluid in the differential pressure meter.

19. The particle monitoring system (1) according to claim 11, wherein the particle filter (8) is a HEPA filter.

20. The method for monitoring particles of a sample fluid according to claim 12, wherein the mass flow rate of the sample fluid flowing through the flow path is determined by measuring a pressure difference of the sample fluid upstream and downstream of a nozzle through which the sample fluid flows.
